(19) United States
(12) Patent Application Publication
(10) Pub. No.: US 2015/0178756 A1
(43) Pub. Date: Jun. 25, 2015

(54) SURVEY PARTICIPATION RATE WITH AN INCENTIVE MECHANISM

(71) Applicant: International Business Machines Corporation, Armonk, NY (US)

(72) Inventors: Tian-Jy Chao, Bedford, NY (US); Younghun Kim, White Plains, NY (US)

(73) Assignee: INTERNATIONAL BUSINESS MACHINES CORPORATION, Armonk, NY (US)

(21) Appl. No.: 14/136,694

(22) Filed: Dec. 20, 2013

(51) Int. Cl. G06Q 30/02

(52) U.S. Cl. CPC G06Q 30/0217

(57) ABSTRACT

An incentive mechanism may comprise computing an incentive score for a participant based on one or more attributes of the participant clustered by the attributes and an individual incentive sensitivity, subject to the campaign specifics of campaign goal and the incentive resource constraints. An optimal incentive amount to distribute to the participant and frequency of distribution to the participant may be determined based on at least the incentive score, the incentive amount optimized to maximize the incentive resource (total budget) given to said participants in a cluster of participants. One or more responses from the participant may be monitored and observed as a result of distributing the incentive amount. Based on the responses, individual incentive sensitivity may be determined, which may be used to further determine an optimized incentive amount.

### CROSS-REFERENCE TO RELATED APPLICATIONS

This application is related to U.S. patent application Ser. No. ______ (Attorney Docket YOR920130283US2 (30250)) entitled “END-TO-END EFFECTIVE CITIZEN ENGAGEMENT VIA ADVANCED ANALYTICS AND SENSOR-BASED PERSONAL ASSISTANT CAPABILITY (EECEASPA),” filed on ______, U.S. patent application Ser. No. ______ (Attorney Docket YOR920130626US1 (30238)) entitled “METHOD AND APPARATUS FOR EFFECTIVE ANALYZING THE ACCURACY/TRUSTWORTHINESS OF SURVEY ANSWERS THROUGH TRUST ANALYTICS,” filed on ______, and U.S. patent application Ser. No. ______ (Attorney Docket YOR920130849US1 (30440)) entitled “PERTURBATION, MONITORING, AND ADJUSTMENT OF AN INCENTIVE AMOUNT USING STATISTICALLY VALUABLE INDIVIDUAL INCENTIVE SENSITIVITY FOR IMPROVING SURVEY PARTICIPATION RATE,” filed on ______, the entire content and disclosure of which are incorporated by reference herein in their entirety.

### FIELD

The present application relates generally to computers, and computer applications, and more particularly to citizen engagement and analytics.

### BACKGROUND

Different campaigns possess different characteristics (also known as campaign specifics), e.g., campaign criteria, requirements of recruitment and goals, which, if not addressed specifically or provided with appropriate amount of the incentives to the right participants, can often render the campaigns ineffective. For example, the campaigns may be unable to maximize the incentive resources or allocate the right incentive amount to motivate the participants to produce the intended level of responses and attract the appropriate types of people in the right geographic location, demographic group, e.g., age, education, income, to respond to the campaign for it to be successful.

### BRIEF SUMMARY

A method of providing an incentive mechanism for survey participation in a campaign, in one aspect, may comprise receiving information associated with a campaign goal and incentive resource constraints, the incentive resource constraints comprising at least a total amount of incentive resource, the information comprising at least campaign specifics. The method may also comprise identifying participants for a survey, the participants having one or more attributes. The method may further comprise clustering the participants into one or more clusters according to the one or more attributes. The method may also comprise computing an incentive score for a participant in a cluster of said one or more clusters, based on one or more attributes of the participant and individual incentive sensitivity, subject to the campaign goal and the incentive resource constraints. The method may further comprise determining an incentive amount to distribute to the participant and frequency of distribution to the participant based on at least the incentive score, the incentive amount optimized to maximize the incentive resource given to said participants in the cluster. The method may also comprise distributing the incentive amount to the participant according to the frequency of distribution. The method may further comprise monitoring and observing one or more responses received from the participant. The method may also comprise updating the individual incentive sensitivity based on the monitoring and observing, responsive to determining that the individual incentive sensitivity changed by a predefined threshold. The method may also comprise repeating computing of the incentive score, determining of the incentive amount, distributing and monitoring and observing based on the individual incentive sensitivity that is updated.

A system of providing an incentive mechanism for survey participation in a campaign, in one aspect, may comprise one or more computer processor components programmed to perform: receiving information associated with a campaign goal and incentive resource constraints, the incentive resource constraints comprising at least a total amount of incentive resource, the information comprising at least campaign specifics; identifying participants for a survey, the participants having one or more attributes; clustering the participants into one or more clusters according to the one or more attributes; computing an incentive score for a participant in a cluster of said one or more clusters, based on one or more attributes of the participant and an individual incentive sensitivity, subject to the campaign goal and the incentive resource constraints; determining an incentive amount to distribute to the participant and frequency of distribution to the participant based on at least the incentive score, the incentive amount optimized to maximize the incentive resource given to said participants in the cluster; distributing the incentive amount to the participant according to the frequency of distribution; monitoring and observing one or more responses received from the participant; updating the individual incentive sensitivity based on the monitoring and observing, responsive to determining that the individual incentive sensitivity changed by a predefined threshold; and repeating computing of the incentive score, determining of the incentive amount, distributing and said monitoring and observing based on the individual incentive sensitivity that is updated.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a flow diagram that illustrates an overall flow of incentive analytics in one embodiment of the present disclosure.

FIG. 2 is a flow diagram that illustrates an incentive score computation in one embodiment of the present disclosure.

FIG. 3 is a flow diagram illustrating an incentive optimization in one embodiment of the present disclosure.

FIG. 4 is a flow diagram that illustrates incentive distribution in one embodiment of the present disclosure.

FIG. 5 is a flow diagram illustrating incentive score perturbation in one embodiment of the present disclosure.

FIG. 6 is a flow diagram illustrating a calculation of individual incentive sensitivity in one embodiment of the present disclosure.

FIG. 7 is a graphical plot that shows a sample output of regression analysis in one embodiment of the present disclosure.

FIG. 8 illustrates a schematic of an example computer or processing system that may implement a system in one embodiment of the present disclosure.

### DETAILED DESCRIPTION

Adhoc management of campaigns lacks a systematic analysis on ways to perturb, monitor, and adjust an incentive amount based on an individual person's incentive sensitivity to the changes of incentive amount. Such systematic analysis may be statistically valuable, e.g., to optimize the allocation of the total incentive resources and to improve the survey participation rate.

Behavior objectives may be to measure sensitivity of participants in a sense of engagement or campaign, and also applicable to other contexts, e.g., marketing, utility usage (e.g. water, electricity), carpooling, purchase of products or services, e.g., on remote platforms such as on a cloud or in the travel space such as hotel, plane, loyalty program incentive design of retail stores, and others.

Citizen engagement or Campaign refers to city (or another organization) or citizen initiated activity that has a goal statement, timeline, and qualification for participation.

Campaign Definition may define a campaign (or engagement) specifying various attributes such a goal that is created, start and end dates, targeted demographic groups (e.g., age groups) of volunteers, targeted geographic areas, task for the volunteers to do (e.g., vote for a new park location), incentive definitions, rules to dynamically adjust incentives, and success metrics or measurement metrics, and/or others.

Campaign Announcement or Launch may include generating a campaign, e.g., a campaign Web page and automatically pushing announcement to social media channels, such as social networking channels, social micro-blogging and/or social blogging channels.

Campaign Recruitment (online) may enable citizens to register as campaigners and campaigners to update recruitment status; enable citizens to register as volunteers and perform the task they are recruited for, right there where they are registered; enable businesses (organizations or citizens) to register as sponsors; display campaign recruitment status for social approval.

Campaign Activity Reporting and Analysis may aggregate display of campaign progress of near real-time activity status for general public consumption and for use by the campaign administrators. Examples of the activity status may include viewed, liked, followed, response rate, most followed people, temporal statistics and advanced analytics for staff consumption, which enable near real-time monitoring of the progress of the campaign status and adjustments of incentive based on the response rate and coverage.

Sensor-based data refer to data collected using a variety of wireless (e.g., Bluetooth) sensing devices, e.g., Pulse oxy meter, Heart, beat monitor, Blood sugar monitor, Pedometer, etc.

The individual “incentive sensitivity” refers to the responsiveness of a person to the changes of the incentive amount, e.g., how a person responds to the amount of an incentive change, e.g., if monetary incentive is being offered, how a participant (also referred to as a volunteer) responds to changes in the monetary amount, e.g., $1, $5, to $10.

The following illustrates some examples of campaign criteria or goals: Drive as many submissions as possible; Drive as many reliable (trustworthy, high quality, and/or accurate, etc.) submissions as possible; Drive as frequent submissions as possible; Provide more incentives to participants that meet certain attributes, e.g., location, demographic, financial, etc. In another aspect, a campaign criterion need not have any preferences. Yet in another aspect, a campaign criteria may include measuring the effectiveness of a campaign, e.g., by computing delta (e.g., Effectiveness=Goals or Objectives−Current status).

In one embodiment of the present disclosure, an incentive analytics may be provided for improving survey participation rate with an incentive mechanism that optimizes the incentive returns. The incentive returns may be optimized by optimizing the allocation of incentives resources and providing dynamic adjustment of incentive allocation based on a participant's individual incentive sensitivity to the changes of the incentive amount. The incentive analytics may provide systematic analysis to produce optimal distribution of the incentives resources, e.g., by employing the following mechanisms or components: an incentive score computation engine, an incentive optimizer, an incentive distribution engine, and an incentive response observer.

The incentive score computation engine may compute an incentive score for use to distribute the incentive for each participant, e.g., based on the following: 1) various input attributes selected as per the campaign goals, 2) the individual's incentive sensitivity to the changes of the incentive amount. To start, default sensitivity may be assumed for all users, and the incentive response observer may update the individual incentive sensitivity in subsequent iteration.

The incentive optimizer may optimize incentive allocation based on the constraint of the incentive total by analyzing various aspects of how incentives are allocated to campaign participants, e.g., amount of the incentives given, frequencies of the incentives given, and the responses of the participants to the incentives. The incentive optimizer may maximize the campaign effectiveness subject to the campaign goals and incentive resource constraints by constructing an optimization problem in a mathematical formula and solving the optimization problem by selecting the most suitable optimizer. In one embodiment of the present disclosure, outputs are personalized, e.g., optimized incentive amount and frequency of incentive distribution may be computed for each participant.

The incentive distribution engine may distribute the incentive to each participant based on the amount and frequency designated by the incentive optimizer. The incentive distribution engine works with the incentive optimizer to dynamically adjust the amount of incentive allocation and the frequency of delivery to each participant based on how the participant is responding to the incentives.

The incentive response observer may use random perturbation of incentive amount to arrive at statistically valuable incentive amount to examine incentive sensitivity change determined to be significant (the degree of significance may be defined based on a threshold) via, e.g., a statistical analysis such as a clustered regression analysis of individual incentive sensitivity. That is, in one embodiment, the incentive response observer perturbs the incentive amount, monitors each participant's individual incentive sensitivity, adjusts the incentive amount for a cluster of participants to arrive at an incentive amount that is statistically valuable. The incentive response observer determines whether the “change” to the incentive sensitivity is significant (e.g., exceeds or meets a threshold). If the incentive sensitivity is determined to be significant, the incentive response observer triggers the incentive optimizer to recalculate the incentive score and compute the new incentive amount based on the recalculated incentive score. If the incentive sensitivity is determined not to be significant, the current sensitivity may be continued to be used. The individual incentive sensitivity is an output of the incentive response observer and input to the incentive score computation engine.

The methodology disclosed herein may be used for survey taking in one embodiment of the present disclosure. The methodology may include determining optimal incentive to one or more participants in a target population subject to the objectives and total incentives.

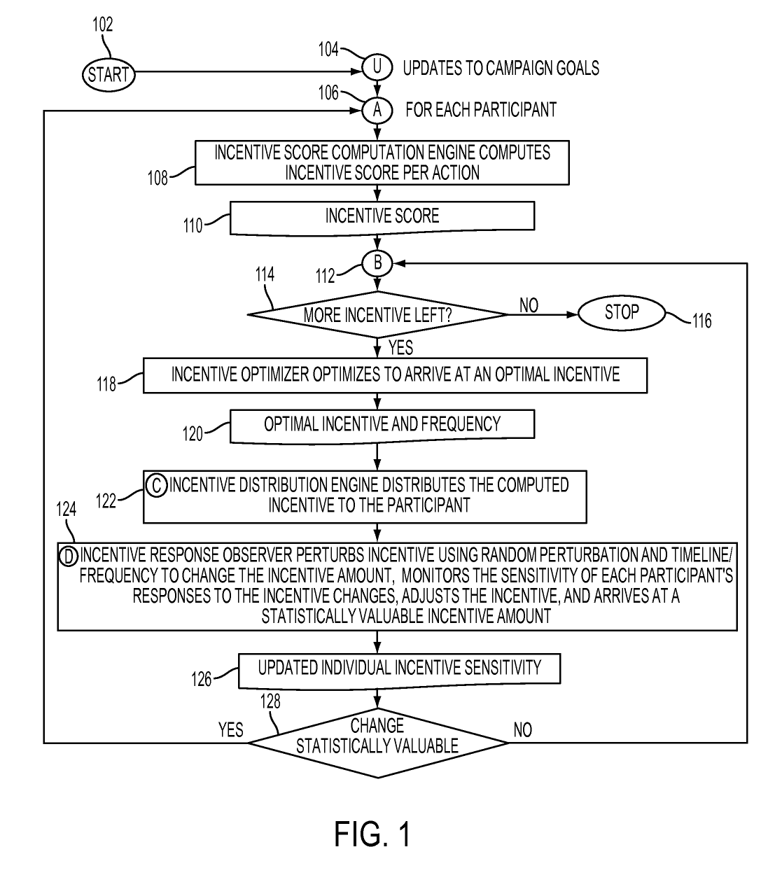

FIG. 1 is a flow diagram that illustrates an overall flow of incentive analytics in one embodiment of the present disclosure. At 102, the analytics may begin. At 104, updates to one or more campaign goal may be received. At 106, based on the campaign goals, the processing shown in FIG. 1 may be performed. In one aspect, the processing at 108 to 122 may be performed for each participant. The processing at 124-128 may be performed for each participant with respect to a group of participants. For instance, the participants (e.g., by participant identifiers or other identifying information) in the target population may be obtained or identified. The participants may have one or more attributes. One or more clusters of the participants may be created according to the one or more of the attributes of the participants (e.g., the participants are grouped or clustered into one or more clusters based on their attributes), and the processing at 124-128 may apply to the one or more clusters.

The following describe examples of input to the processing beginning at 108: Primary attributes may include a user identifier (UID); Location+Timestamp (e.g., Latitude, Longitude, Time); Prior campaign responses including response frequency, response quality (e.g., accurate prior reporting, picture quality), other data quality, and campaign context; trust score to assign incentive score (representing the trustworthiness of participant response); and impact score (e.g., how a participant is impacted, e.g., by a certain proposal and/or with respect to some other location, e.g., bus stop, park location, etc.) to assign incentive score. A trust score and an impact score may be computed according to a methodology disclosed in U.S. patent application Ser. No. ______ (Attorney Docket YOR920130626US1 (30238)). Secondary attributes may include demographic information (e.g., age, occupation, education level, financial data, e.g., income, house ownership, mobility preferences such as public transit, bike, or cars, or others, skills, ownership of devices, e.g., smartphones, and appliances, and others; Social networking posting, e.g., textual input such as affirmative posting towards sustainability; Smarter meter and other natural resource data, e.g., water, electricity, gas, etc.; Other data provided by users, e.g., health risk assessment (HRA) related data, e.g., questionnaire responses, sensor-based data, e.g., smartphones, and others.

Attributes may also include prior history of participant responses, e.g., frequency of response, quality of response (e.g., accurate prior reporting, picture quality), other data quality, campaign context, and/or sensor-based data. One or more attributes may have an impact on a participant, e.g., sales revenue, adoption of a plan, use (or decline of use) of resources such as energy and water, action regarding community good will such as walkable streets, aesthetics of neighborhoods, community watch for public safety, and so forth. The attributes may also include geographical vicinity to the location of the target site in question, e.g., a distance from the participant to a bus stop and/or to other building or site locations, participant income.

At 108, an incentive score per action may be computed for a participant, e.g., by an incentive score computation engine that may run on a computer or a computer processor. “Per action” refers to each time a participant takes an action, e.g., posts a comment, submits a photo, drives/walks through paths, submits an answer to specific question or questions. The incentive score may be computed using one or more of the attributes of the participants and the individual incentive sensitivity subject to campaign goals and incentive resource constraints. The attributes may include a unique ID, location, a trust score, geographical vicinity to the location of the target site, etc. The attribute also may include something that has an impact on a participant. The impact may be sales revenue, adaption of a plan, use of resources, etc. An incentive score per action may be computed using individual incentive sensitivity as input and a selected incentive score calculation rule to select and execute a corresponding known algorithm to compute an incentive score for a participant.

For example, equation (1) below may be used to compute this incentive score. Hence at 110, an incentive score is obtained. The computed incentive score is used below in determining an incentive or incentive amount to distribute to the participant, e.g., as shown in Equation (2).

At 112, the processing proceeds to 114. At 114, it is determined whether more incentive is left. If there are no more incentives, the processing may stop at 116.

If at 114, there are more incentives, an optimal incentive may be computed, e.g., by an incentive optimizer that may run on a computer or a computer processor 118. The incentive optimizer thus may produce an optimal incentive and frequency as shown at 120. The incentive optimizer may maximize the campaign effectiveness subject to the campaign goals and incentive resource constraints (e.g., total incentive amount or budget available for the campaign), e.g., by constructing an optimization problem in a mathematical formula and solving the optimization problem by selecting the most suitable optimizer to compute an optimal incentive amount and frequency of distribution to each participant.

Thus, for example, the incentive amount is optimized to maximize campaign resources by producing a personalized optimal incentive amount and frequency of distribution for each participant. The optimization of the total incentive amount may be based on a formula to output personalized optimal incentive amount and frequency of incentive distribution for each participant.

At 122, the computed incentive may be distributed to the participant, e.g., by an incentive distribution engine that may run on a computer or a computer processor. For instance, an electronic coupon, discount, a gift may be distributed electronically over a computer network (e.g., the Internet) to the participant, e.g., via an email, web page post, or such another mechanism. In another aspect, the incentive may be distributed physically, e.g., by mail, courier, or another such mechanism.

At 124, the computed incentive may be perturbed, e.g., by an incentive response observer that may run on a computer or a computer processor, using random perturbation and timeline (or frequency) to change the incentive amount. The incentives may be perturbed to dynamically adjust the incentive amount based on individual incentive sensitivity showing up as behavioral changes in the response rates to the incentive and its changes at the time incentives are given.

For example, the computed incentive may be perturbed to maximize the campaign resources for optimizing the incentive amount to each participant by modeling the responsiveness of a participant (or a cluster of participants) using at least three parameters: an incentive delta (change of the incentive amount paid to a participant), incentive frequency (distribution frequency or interval to a participant) and responsiveness delta (change of incentive sensitivity of a participant to the incentive delta and/or incentive frequency), to compute an individual incentive sensitivity for each participant. The sensitivity of each participant's response to the incentive changes may be monitored, e.g., the changes in frequency of responses of the participant may be observed to identify changes (e.g., above a threshold) in individual incentive sensitivity. For instance, the individual incentive sensitivity of responsiveness may be analyzed and calculated per incentive change, e.g., using statistical analysis, e.g., regression analysis (e.g., by a participant or by each cluster of participants).

Hence, at 126, individual incentive sensitivity that may be adjusted based on the computation from perturbation is obtained. An example of the responsiveness may be the number of bus trips per week the participant takes. The incentive distribution and frequency may be how frequently an incentive is distributed by the incentive distribution engine, e.g., a $2 coupon per each comment posting.

At 128, it is determined whether the individual incentive sensitivity change is statistically valuable. Whether the change is statistically valuable may be defined, e.g., as a threshold or criterion, e.g., on descriptive statistics such as sample variance, mean, median, etc. If so, the logic of the methodology returns to 106, to recompute the incentive score based on the computed sensitivity and to repeat the processing.

If at 128, the change is determined to be not statistically valuable, the logic of the methodology may return to 112 to see if there are any incentives left, and if there are incentives remaining, follow the steps of 118 to 128 to perform optimization and perturbation and adjustment for another incentive to distribute. Otherwise, the process stops at 116.

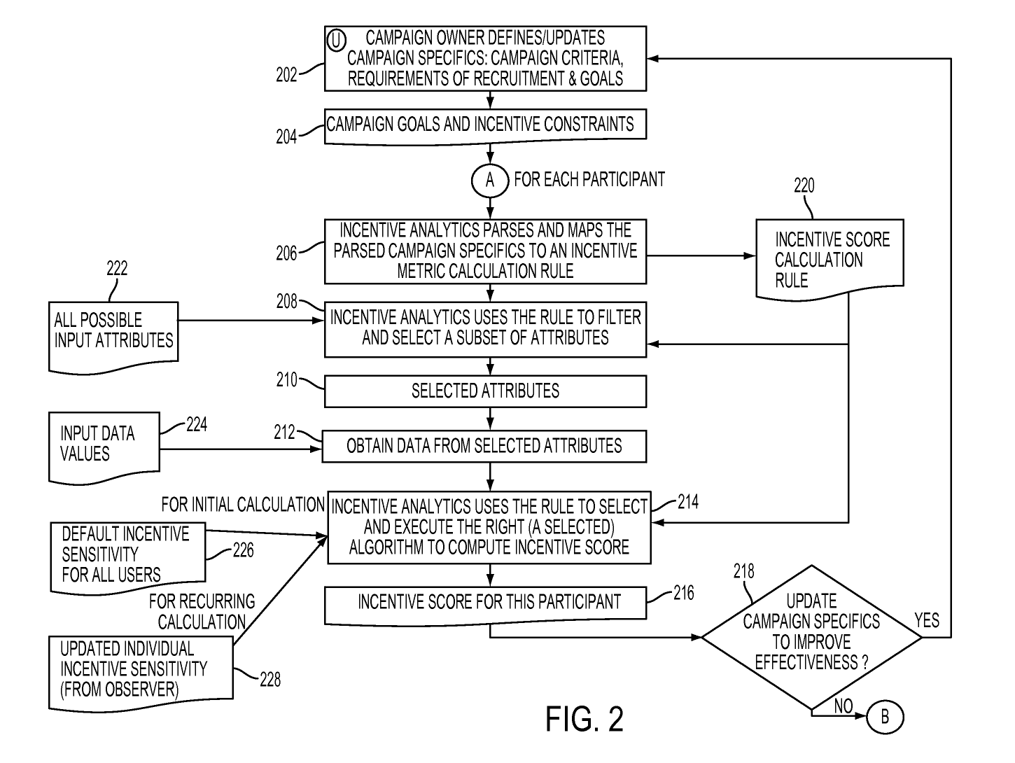

FIG. 2 is a flow diagram that illustrates an incentive score computation in one embodiment of the present disclosure. One or more campaign goals and incentive constraints may be obtained or received at 204, for example, from a campaign owner who defines and/or updates specific information about a campaign, e.g., campaign criteria, requirements of recruitment and goals.

At 206, the information about the campaign (e.g., one or more campaign criteria, requirements of recruitment and goals, etc) is parsed to obtain campaign specifics, which are then mapped to an incentive score calculation rule 220. U.S. patent application Ser. No. ______ (Attorney Docket YOR920130626US1 (30238)) describes this technique in more detail.

At 208, the incentive score calculation rule and parsed campaign specifics 220 are used to filter the most relevant input attributes from the parsed input attributes 222, which can affect the campaign effectiveness and outcome. At 210, the filtered attributes are selected. For instance, a subset of the input attributes are selected from 222 (all possible attributes) based on the parsed campaign specifics 206. As an example, the campaign goal may be as follows: want to improve the frequency of participation in the electricity conservation campaign from Y population group over X years living in South West of the town. The ‘parsed campaign specifics’ would include these four:
a. [frequency (mapped to ‘Frequent Responder’ rule),
b. Y population group (selecting ‘population group’ 2^{nd}-ary attribute),
c. >X years (for selecting ‘age’ 2^{nd}-ary attribute),
d. South West of the town (for selecting ‘location’ primary attribute)]

At 212, data is obtained, both historical and current, using the selected attributes, from input data values 224. For instance, input data values 224 are the data values from the selected input attributes, in the example above, the attributes are population group, age, and location. The data values of a participant may be: Y population group, X years, and address of a street name in South West of the town.

At 214, the incentive score calculation rule is used to select and apply the most appropriate algorithm to compute an incentive score using the selected attribute values and an incentive sensitivity value. A default incentive sensitivity value 226 for all users may be used for initial calculation; subsequently, the individual incentive sensitivity 228 that is updated by the incentive response observer for each participant may be used for recurring calculation.

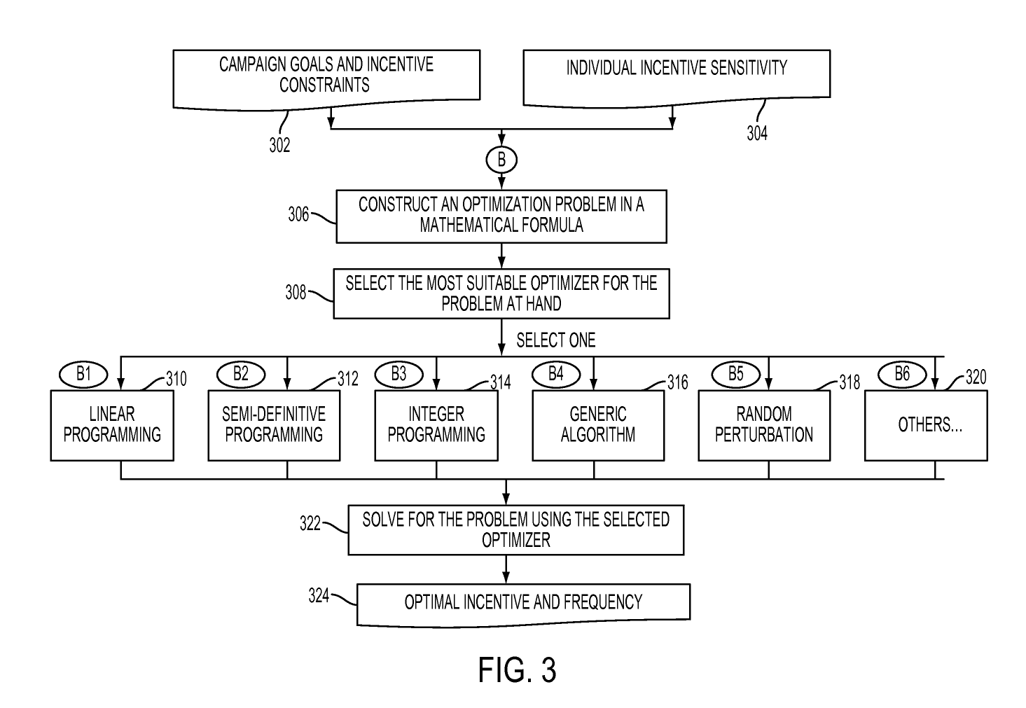

At 216, an incentive score is computed for a participant. At 218, the processing repeats, e.g., the logic returns to 202 to repeat the processing, if for example, there is an update to the campaign specifics. The processing shown in FIG. 2 may be also repeated, e.g., if there is updated incentive sensitivity for a participant. At 218, if there are no updates to the campaign specifics, the processing logic may proceed to optimize the computed incentive score, for example, as shown in FIG. 3, otherwise use the incentive score. The processing shown for computing an incentive score in FIG. 2 may be performed for each participant identified for the campaign.

In one embodiment, an incentive score calculation rule may comprise the following components for calculating an incentive score: selected input attributes; algorithm (name and formula using the selected input attributes); and individual incentive sensitivity (a sensitivity value associated with a participant that is indicative of the participant's sensitivity to incentive changes).

An incentive score calculation rule may be defined, for example, by a user. For instance, a user may select attributes and assign a corresponding weight to each of the selected attributes, which attributes and weights may be specified in an incentive score calculation rule. For example, there may be an incentive score calculation rule defined for reliable responders (participants who responded most with most reliable responses), an incentive score calculation rule defined for frequent responders (participants who responded most frequent), an incentive score calculation rule defined for many responders (participants who responded the most times), and others. Thus, which incentive score calculation rule to use for computing an incentive score for a participant may depend on one or more attributes of the participant.

The incentive score calculation rule also may specify an algorithm or formula for computing the incentive score. Examples of such algorithm may include one or more of weighted linear sum, auto-regressive moving average, binary decision technique, Chi-squared Automatic Interaction Detector, Classification and Regression Tree, or generalized linear model. An example formula is shown in Equation (1) below.

FIG. 3 is a flow diagram illustrating an incentive optimization in one embodiment of the present disclosure. Optimization of an incentive score, e.g., computed according to the methodology shown in FIG. 2, may utilize input data that may comprise campaign goals and incentive constraints 302, and individual incentive sensitivity 304.

At 306, an optimization problem may be constructed as a mathematical formula. An example of such mathematical formula includes Equation (4) shown below.

At 308, the most suitable algorithm or optimizer for the problem at hand may be selected. Algorithms or optimizers from which a suitable one may be selected may include linear programming 310, semi-definitive programming 312, integer programming 314, generic algorithm 316, random perturbation 318, and other 320. At 322, a selected algorithm may be used to compute optimized incentive and frequency 324. For instance, a rule may determine the corresponding algorithm or optimizer, e.g., a user selected attributes and weights uses weighted linear sum algorithm, both reliable responders rule frequent responders rule may use autoregressive moving average (AR), geographic vicinity rule may use Eucledean distance+travel distance, many responders rule may use previous campaign response history, qualification rule may use a binary decision based on prior occupation, current occupation, age, and other attributes to identify qualified individuals; geographic coverage rule may use a threshold to determine a location coverage (in terms of location trace on a map) based on typical mobility of an individual on a specific map.

The optimizer may optimize the incentive returns by identifying the optimal frequency and the amount of the incentive so as to maximize the number of participants that can receive the incentive, and deliver it in a variable amount based on a participant's reputation and trustworthiness, e.g., more incentive for more trustworthy participants. The incentive analytics may divide the total amount of incentives provided at the survey design time into smaller chunks wherein a smaller chunk is offered to a participant who will likely to accept it by completing survey questions to increase the potential response rate of the participants.

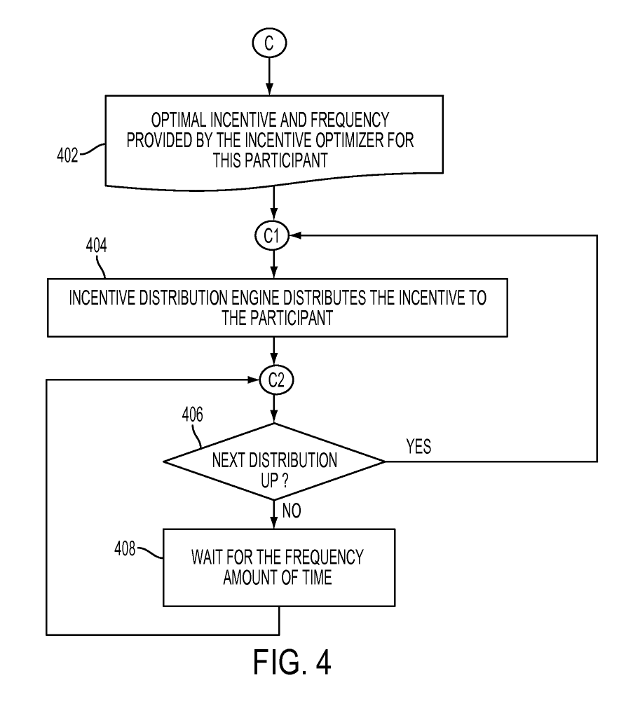

FIG. 4 is a flow diagram that illustrates incentive distribution in one embodiment of the present disclosure. At 402, optimal incentive and frequency, e.g., provided by the incentive optimizer of a participant is received. At 404, the incentive distribution engine distributes the incentive to the participant. At 406, it is determined whether the next distribution should be made, for example, based on the frequency received at 402. For example, a campaign may have a period duration during which incentives are distributed. The frequency may specify the number of distributions that should be made during that period. In another aspect, the frequency may be specified in terms of time interval. At 406, if it is determined that another incentive should be distributed, the logic of the flow proceeds to 404. Otherwise at 408, the logic waits for the next distribution, specified by the frequency.

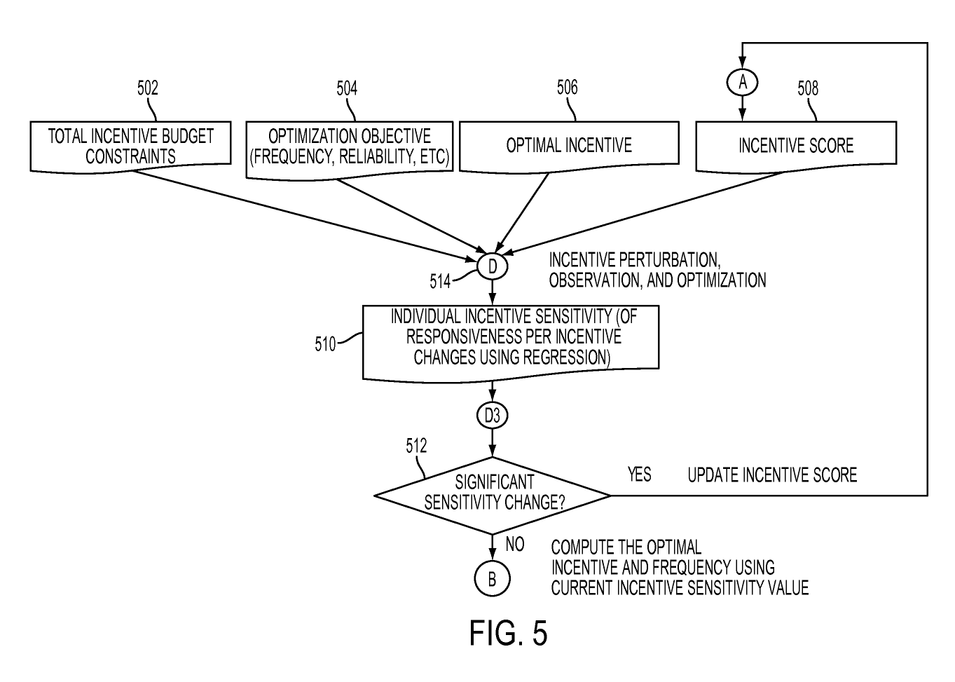

FIG. 5 is a flow diagram illustrating incentive score perturbation in one embodiment of the present disclosure. Incentive perturbation, observation and optimization may be performed at 514 based on received input values of total incentive budget constraint(s) 502, optimization objective (e.g., frequency, reliability, and/or others) 504, an optimal incentive 506 and an incentive score 508. Optimal incentive 506, e.g., may have been computed based on Equation (4) below. Incentive score 508 may have been computed based on Equation (1) below. The computation at 514 may use regression to produce an individual incentive sensitivity of responsiveness per incentive change 510. At 512, it is determined whether a significant sensitivity change is detected. The significance of change may be determined based on a criterion or a threshold; For instance, if the sensitivity change exceeds a predetermined threshold or meets another criterion, the change may be determined as being significant. If the change is determined to be significant, the logic proceeds to recomputed the incentive score, to use as an input in the next iteration. On the other hand, if at 512 the sensitivity change is determined to be not significant, the logic proceeds to compute the optimal incentive (e.g., using Equation (4)) and frequency using current individual incentive sensitivity value.

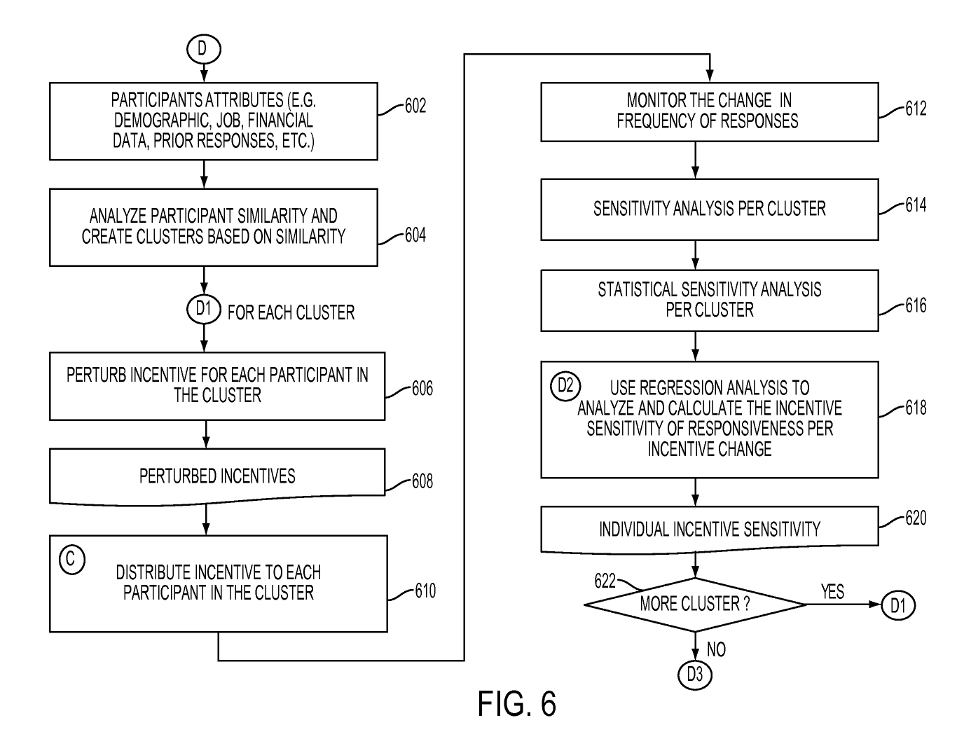

FIG. 6 is a flow diagram illustrating a calculation of individual incentive sensitivity in one embodiment of the present disclosure, e.g., performed at 514 in FIG. 5. At 602, participants' attributes are obtained or received. At 604, participant similarity is analyzed and a cluster of participants is created based on the analyzed similarity. For instance, participants having similar attributes may be grouped (e.g., have the same age range, live or work in the same geographic area, have responded to prior surveys at least X number of times, and/or other attributes).

At 606, for each cluster, incentive is perturbed for each participant in the cluster. For example, subject to the total incentive constraints, an incentive response observer or the like that may run on a computer or computer processor may use random perturbation and timeline (frequency) to change the incentive amount and adjusts the incentive amount based on individual sensitivity to the incentive changes. For instance, Equation (3) below may be employed for this perturbation. For instance, the current incentive may be increased or decreased by a “random amount” within the budget constraint. Likewise, the frequency of incentive distribution may be randomly perturbed or changed. Such random number and random interval in perturbation can reach the statistically valuable number faster and more accurately than using a “fixed amount” or a fixed period and/or evenly distributed intervals via the use of statistical analysis, e.g., regression analysis.

At 608, the perturbed incentives are obtained for each participant in the cluster. At 610, the perturbed incentive is distributed to the participants in the cluster, e.g., to each participant in the cluster.

At 612, the changes, if any, in the frequency of responses from the participants are monitored. For instance, each participant's response or individual sensitivity to the incentive changes may be monitored. If the response is positive toward the campaign goals (e.g., participants increase the frequencies and/or accuracy of responses), the same amount of incentive may be delivered until reaching statistically valuable incentive number.

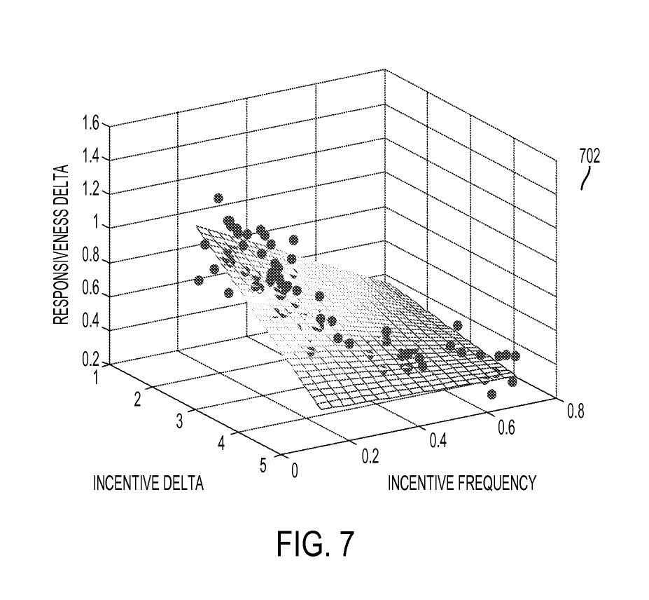

A regression analysis is a standard technique where an underlying dynamics of a sample population can be described with a few parameters of a given model. For example, as shown in FIG. 7, 702, a sensitivity of a group of people (participants) can be described by three variables such as Incentive Frequency, Incentive Delta, and Responsiveness Delta where a model in 702 is a plane in a Cartesian coordinate system. While the measured behavior of the group differs (shown with dots), it can be parameterized using two major variables; a normal vector and an offset. Several statistical measures can be identified using the distance measure between the regression model with parameters and measured points.

If response is negative with respect to the campaign goals (e.g., decrease in participation or inaccurate responses), the base incentive may be used and the random perturbation started again, until participants' responses turn positive, keeping the incentive perturbation within the incentive budget.

At 614, sensitivity analysis may be performed per cluster. This may involve or use the following steps: (a) a clustering of participants by chosen attributes (e.g., shown at 604), (b) running a regression model of observed behavior to create a parameterized incentive sensitivity model for the cluster (e.g., shown at 618), and (c) extracting parameters of regression model 618. The parameters (with values varied per each participant) are used to plug into the cluster-based incentive sensitivity model (shown at 618) to calculate individual incentive sensitivity of each participant (shown at 620).

At 616, statistical sensitivity analysis per cluster may be performed. The descriptive statistics described above with reference to FIG. 1 at 128 is compared to determine if there is any change that is above the pre-defined threshold.

At 618, regression analysis may be performed to analyze and calculate an individual incentive sensitivity of responsiveness per incentive change per cluster per participant. Hence, at 620, individual incentive sensitivity is obtained. That is, e.g., the incentive sensitivity model analyzed for a cluster at 618 is used to calculate an individual incentive sensitivity of each participant based on varied parameters in the same cluster 620. Once the individual incentive sensitivity is obtained at 620, it is used to calculate an individual sensitivity score (108 and 110), which is then fed into the incentive optimizer 118 to calculate incentive amount for each individual 120.

At 622, if there are more clusters of participants, the processing logic proceeds to 606. If there are no more clusters of participants, the processing logic may proceed to determine whether there is a sensitivity change that is considered to be significant and if so to update the incentive, e.g., as shown at 512 in FIG. 5. For example, the individual incentive sensitivity that is obtained at 620 (and that is determined to significantly different from the previously computed individual incentive sensitivity), may be used to recompute or update an incentive score, which in turn is used to compute an incentive (e.g., amount of incentive). In this way, an incentive (e.g., incentive amount) may be dynamically adjusted based on individual incentive sensitivity by triggering the re-computation or update of an incentive score (e.g., if it is determined that there is a significant change in individual incentive sensitivity). Whether the change is significant may be determined based on the amount of change exceeding a predetermined threshold.

FIG. 7 is a graphical plot that shows a sample output of regression analysis in one embodiment of the present disclosure, which for example is used at 618 in FIG. 6. The graph 702 shows regression on incentive sensitivity of similar individuals, i.e., cluster of participants grouped by similarity in their attributes. The regression uses at least three parameters: incentive delta, incentive frequency, and responsiveness delta. Incentive delta refers to change is the incentive, e.g., by amount or type or another factor. Incentive frequency refers to how often an incentive is offered. Responsiveness delta refers to the change in participant's responsiveness resulting from change in one or more of the incentive or incentive frequency. Individual's incentive sensitivity using regression analysis produces a statistically valuable amount for use to detect any significant change in the individual's incentive sensitivity. Incentive amount may be adjusted (either positive or negative) accordingly.

Equation (1) is an example formulation that computes and incentive score per participant.

$${Score}^{I} = {S}^{I} {\sum }_{i ∈ Γ} W ( i ) M ( i ) \qquad ( 1 )$$

where

Score^{I} represents Incentive Score

S^{I} represents sensitivity,

W(i) represents weight,

M (i) represents default score,

Γ represents a chosen set of attributes and metrics,

and I represents individual identifier (ID) uniquely identifying a participant.

Initial value of S^{I} may be a default value that is predefined or specified by a user. This value may be then updated by the incentive score observer that perturbs the incentive and/or the frequency of incentive distribution to determine a participant's sensitivy. W(i), M(i), and Γ may be input by a user.

Equation (2) showns incentive computation in one embodiment of the present disclosure, for example, based on which a distribution to a participant may be made (e.g., FIG. 1 at 122, FIG. 6 at 610).

$${Incentive}^{I} = B \frac{{Score}^{I}}{{\sum }_{I ∈ Λ} {Score}^{I}} \qquad ( 2 )$$

where,

I represents an individual identifier (ID) uniquely identifying a participant

Score^{I} represents Incentive Score for the ID

Λ total participant pool

B total budget

Equation (3) is an example formulation that computes incentive score perturbation, which in turn provides perturbation in incentive computed in Equation (2) (e.g., FIG. 1 at 124, FIG. 5 at 514, FIG. 6 at 606).

Score_{ptd}^{I}=Score^{I}+εⱼ (3)

where,

Score_{ptd}^{I}: ptd represents a perturbed incentive score for the ID

I represents an individual identifier (ID) uniquely identifying a participant

Score^{I} represents incentive score for the ID

εᵢ is a random variable

Equation (4) is an example formulation that optimizes the incentive, e.g., which may be used in FIG. 1 at 118.

$$minimize {\sum }_{I ∈ Λ} {Incentive}^{I} \\ subject to {Incentive}^{I} = B \frac{{Score}^{I}}{{\sum }_{I ∈ Λ} {Score}^{I}} \\ {Score}^{I} = {f}^{I} ( A ) \\ where {\sum }_{I ∈ Λ} {Incentive}^{I} \leq B \qquad ( 4 )$$

I represents an individual identifier (ID) uniquely identifying a participant

A represents total participant pool;

B represents total budget;

Score^{I} represents incentive score of I (individual ID)

f^{I}(A) a regression function for I with a chosen vector of attributes A=[aᵢ]

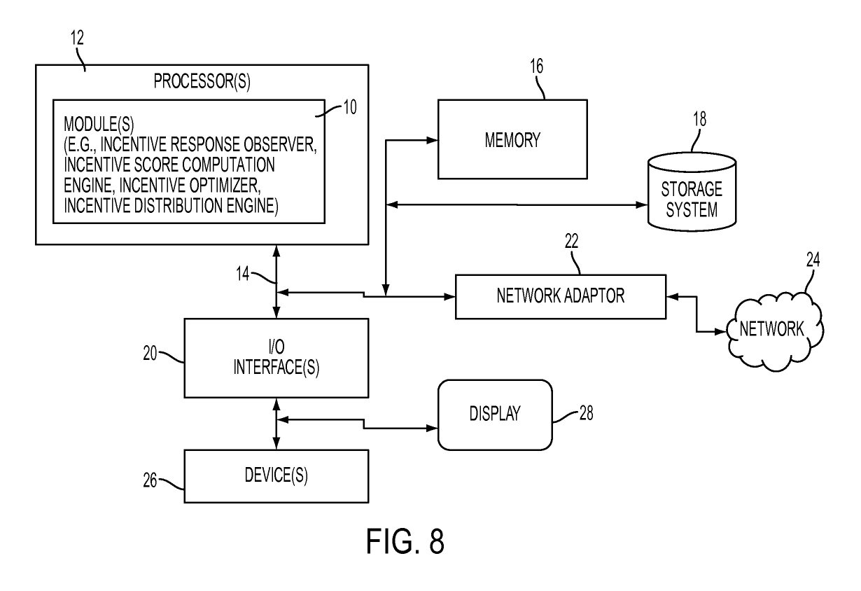

FIG. 8 illustrates a schematic of an example computer or processing system that may implement a system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 5 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include one or more modules 10 that perform the methods described herein. The one or more modules 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method of providing an incentive mechanism for survey participation in a campaign, comprising:
receiving information associated with a campaign goal and incentive resource constraints, the incentive resource constraints comprising at least a total amount of incentive resource, the information comprising at least campaign specifics;
identifying participants for a survey, the participants having one or more attributes;
clustering the participants into one or more clusters according to the one or more attributes;
computing an incentive score for a participant in a cluster of said one or more clusters, based on one or more attributes of the participant and an individual incentive sensitivity, subject to the campaign goal and the incentive resource constraints;
determining an incentive amount to distribute to the participant and frequency of distribution to the participant based on at least the incentive score, the incentive amount optimized to maximize the incentive resource given to said participants in the cluster;
distributing the incentive amount to the participant according to the frequency of distribution;
monitoring and observing one or more responses received from the participant;
updating the individual incentive sensitivity based on the monitoring and observing, responsive to determining that the individual incentive sensitivity changed by a predefined threshold; and
repeating said computing of the incentive score, said determining of the incentive amount, said distributing and said monitoring and observing based on the individual incentive sensitivity that is updated.

2. The method of claim 1, wherein said computing of the incentive score, said determining of the incentive amount, said distributing, said monitoring and observing, said repeating, are performed for each of the participants in the cluster.

3. The method of claim 2, wherein said monitoring and observing comprises
perturbing the incentive amount by performing random perturbation computation;
redistributing said incentive amount that is perturbed to the participant;
observing one or more responses from the participant responsive to said redistributing; and
computing the individual incentive sensitivity based on said observing of said one or more responses from the participant responsive to said redistributing.

4. The method of claim 3, wherein said computing of the individual incentive sensitivity comprises performing a regression analysis that models responsiveness of the participants in the cluster by at least an incentive delta, incentive frequency, and responsiveness delta.

5. The method of claim 1, wherein said determining of the incentive amount comprises:
constructing an optimization problem in a mathematical formula;
solving the mathematical formula by dynamically selecting an optimizer that is determined to be most suitable, wherein the optimizer comprises at least one of Linear Programming, Semi-definitive Programming, Integer Programming, Generic Algorithm, Random perturbation, Weighted Linear Sum, Autoregressive moving average (AR), and Eucledean distance+travel distance,
the optimizer producing the incentive amount and the frequency of distribution that is specific to the participant.

6. The method of claim 1, wherein the one or more attributes comprise at least an attribute that has an impact on the participant based on the campaign specifics.

7. The method of claim 1, wherein said computing of the incentive score comprises:
selecting an incentive score calculation rule based on said one or more attributes of the participant, the incentive score calculation rule comprising at least user specified attributes and corresponding weights to use in computing the incentive score; and
computing the incentive score based on at least the user specified attributes and corresponding weights, and the individual incentive sensitivity.

8. The method of claim 7, wherein the incentive score calculation rule is selected from a plurality of incentive score calculation rules, wherein the plurality of incentive score calculation rules comprises at least a first rule associated with reliable responders that uses Autoregressive moving average algorithm, a second rule associated with frequent responders that uses Autoregressive moving average algorithm, and a third rule associated with many responders that use previous campaign response history, user selected attributes and weights rule that uses Weighted Linear Sum.

9. The method of claim 8, wherein the incentive score calculation rule further comprises an algorithm for computing the incentive score.

10. The method of claim 9, wherein the algorithm comprises one or more of weighted linear sum, auto-regressive moving average, binary decision technique, Chi-squared Automatic Interaction Detector, Classification and Regression Tree, or generalized linear model.

11. A system of providing an incentive mechanism for survey participation in a campaign, comprising:
one or more computer processor components programmed to perform:
receiving information associated with a campaign goal and incentive resource constraints, the incentive resource constraints comprising at least a total amount of incentive resource, the information comprising at least campaign specifics;
identifying participants for a survey, the participants having one or more attributes;
clustering the participants into one or more clusters according to the one or more attributes;
computing an incentive score for a participant in a cluster of said one or more clusters, based on one or more attributes of the participant and an individual incentive sensitivity, subject to the campaign goal and the incentive resource constraints;
determining an incentive amount to distribute to the participant and frequency of distribution to the participant based on at least the incentive score, the incentive amount optimized to maximize the incentive resource given to said participants in the cluster;
distributing the incentive amount to the participant according to the frequency of distribution;
monitoring and observing one or more responses received from the participant;
updating the individual incentive sensitivity based on the monitoring and observing, responsive to determining that the individual incentive sensitivity changed by a predefined threshold; and
repeating said computing of the incentive score, said determining of the incentive amount, said distributing and said monitoring and observing based on the individual incentive sensitivity that is updated.

12. The system of claim 11, wherein said one or more computer processor components performs said computing of the incentive score, said determining of the incentive amount, said distributing, said monitoring and observing, said repeating, for each of the participants in the cluster.

13. The system of claim 12, wherein said monitoring and observing comprises
perturbing the incentive amount by performing random perturbation computation;
redistributing said incentive amount that is perturbed to the participant;
observing one or more responses from the participant responsive to said redistributing; and
computing the individual incentive sensitivity based on said observing of said one or more responses from the participant responsive to said redistributing.

14. The system of claim 13, wherein said computing of the individual incentive sensitivity comprises performing a regression analysis that models responsiveness of the participants in the cluster by at least an incentive delta, incentive frequency, and responsiveness delta.

15. The system of claim 11, wherein said determining of the incentive amount comprises:
constructing an optimization problem in a mathematical formula;
solving the mathematical formula by dynamically selecting an optimizer that is determined to be most suitable, wherein the optimizer comprises at least one of Linear Programming, Semi-definitive Programming, Integer Programming, Generic Algorithm, or Random perturbation,
the optimizer producing the incentive amount and the frequency of distribution that is specific to the participant.

16. A computer readable storage medium storing a program of instructions executable by a machine to perform a method of providing an incentive mechanism for survey participation in a campaign, the method comprising:
receiving information associated with a campaign goal and incentive resource constraints, the incentive resource constraints comprising at least a total amount of incentive resource, the information comprising at least campaign specifics;
identifying participants for a survey, the participants having one or more attributes;
clustering the participants into one or more clusters according to the one or more attributes;
computing an incentive score for a participant in a cluster of said one or more clusters, based on one or more attributes of the participant and an individual incentive sensitivity, subject to the campaign goal and the incentive resource constraints;
determining an incentive amount to distribute to the participant and frequency of distribution to the participant based on at least the incentive score, the incentive amount optimized to maximize the incentive resource given to said participants in the cluster;
distributing the incentive amount to the participant according to the frequency of distribution;
monitoring and observing one or more responses received from the participant;
updating the individual incentive sensitivity based on the monitoring and observing, responsive to determining that the individual incentive sensitivity changed by a predefined threshold; and
repeating said computing of the incentive score, said determining of the incentive amount, said distributing and said monitoring and observing based on the individual incentive sensitivity that is updated.

17. The computer readable storage medium of claim 16, wherein said computing of the incentive score comprises:
selecting an incentive score calculation rule based on said one or more attributes of the participant, the incentive score calculation rule comprising at least user specified attributes and corresponding weights to use in computing the incentive score; and
computing the incentive score based on at least the user specified attributes and corresponding weights, and the individual incentive sensitivity.

18. The computer readable storage medium of claim 17, wherein the incentive score calculation rule is selected from a plurality of incentive score calculation rules, wherein the plurality of incentive score calculation rules comprises at least a first rule associated with reliable responders, a second rule associated with frequent responders, and a third rule associated with many responders.

19. The computer readable storage medium of claim 18, wherein the incentive score calculation rule further comprises an algorithm for computing the incentive score.

20. The computer readable storage medium of claim 19, wherein the algorithm comprises one or more of weighted linear sum, auto-regressive moving average, binary decision technique, Chi-squared Automatic Interaction Detector, Classification and Regression Tree, or generalized linear model.
